(19) United States
(12) Patent Application Publication
(10) Pub. No.: US 2006/0264249 A1
(43) Pub. Date: Nov. 23, 2006

(54) Apparatus and method for radio frequency testing of a wireless communication device

(76) Inventors: Roger L. Scheer, Beach Park, IL (US); Scott A. Bots, Chicago, IL (US); Michael S. Kramer, Gurnee, IL (US); Eric L. Krenz, Crystal Lake, IL (US); Paul J. Moller, Lake Zurich, IL (US); Stanley J. Rosa, Crystal Lake, IL (US); Matthew R. Brown, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/135,200

(22) Filed: May 23, 2005

(51) Int. Cl. H04M 1/00

(52) U.S. Cl. 455/575.2

(57) ABSTRACT

An apparatus for radio frequency testing of a wireless communication device (205) comprising an artificial head (100) and a spacer (203). The artificial head (100) includes a mouth (103) and an ear (105, 107), and the spacer (203) is positioned adjacent to the artificial head (100). The spacer (203) positions an audio output portion of the wireless communication device (205) adjacent to the ear (105, 107) of the artificial head (100), directs an audio input portion of the wireless communication device (205) toward the mouth (103) of the artificial head (100), and separates the audio input portion of the wireless communication device (205) from the mouth (103) of the artificial head (100).

### FIELD OF THE INVENTION

The present invention relates in general to radio frequency (“RF”) test equipment. More particularly, the present invention relates to equipment used to evaluate the effect of the human body on signals directed to and from wireless communication devices.

### BACKGROUND OF THE INVENTION

Wireless communication devices, including handheld cellular telephones, dedicated text messaging devices, and hybrid devices that combine communication and other functions, generally include antennas that are used to transmit and receive information-bearing RF and/or microwave signals. Antennas can be characterized by the efficiency with which they radiate and receive signals and by their gain patterns, which characterize how well the antenna can transmit and receive signals in each direction.

Handheld wireless communication devices differ from larger radio communication equipment in that they are typically operated in close proximity to a person's body, e.g., held at the side of a person's face. From a radio frequency view point, the human body is an irregularly shaped object in which the complex permittivity (conductivity and permittivity) is spatially distributed. Although considered in isolation, an antenna of a wireless communication device can be analyzed and understood using a variety of mathematical methods, placing the antenna near a person's body complicates matters and can dramatically change the performance of the antenna from what is predicated based on mathematical models of the antenna in isolation. Interaction with a person's body may lead to loss of signal energy, and alteration of the gain pattern.

In order to better understand the effect of a user's body on antenna performance, models of the human head that are suitable for radio frequency testing have been made. These models typically take the form of a hollow molded model of a head that is filled with an electrolyte solution that is intended to simulate the bulk radio frequency properties of a person's head. Models of a human hand have also been a gloved hand or constructed from carbon-and-aluminum loaded silicone rubber.

A major source of error in RF chamber measurements using the phantom head and hand is attributed to the variability of positioning the phone and hand on the head from one measurement to the next. This variability is larger than other RF chamber measurements involving just the head because the measurement requires the added variability of placing both the phone and hand onto the head. The root causes of this added variability include the positioning of the phone on the ear, the variability of the spacing between the phone and the cheek, and the positioning of the phantom hand onto the head and phone.

Consistent and reliable repeatability for RF testing equipment, such as equipment that uses a phantom and hand, is relatively difficult to maintain. In particular, the spacing between the hand and phone, and the exact positioning of the phone on the head and hand, are a challenge to maintain. Even minor changes or inexact spacings and positions can have significant effects on RF measurements.

Accordingly, there is a need for a positioning apparatus and method that provide consistent and reliable repeatability of testing equipment for obtaining RF measurements. Also, there is a further need for an adjustable physical support for the hand to maintain the position of the hand relative to other components.

### BRIEF DESCRIPTION OF THE DRAWINGS

FIG. 1 is a front planar view of an exemplary artificial head.

FIG. 2 is a front, perspective view of a spacer, in accordance with the present invention, supporting a wireless communication device to the artificial head of FIG. 1.

FIG. 3 is a rear, perspective view of the spacer and the wireless communication device of FIG. 2.

FIG. 4 is another rear, perspective view of the spacer of FIG. 2.

FIG. 5 is an upper, perspective view of the spacer, the wireless communication device and the artificial head of FIG. 2, and, also, a pedestal that supports the artificial head as well as an artificial hand and a hand base.

FIG. 6 is a lower perspective view of the hand base of FIG. 5

FIG. 7 is an upper, perspective view of the pedestal of FIG. 5.

### DETAILED DESCRIPTION OF THE PREFERRED EMBODIMENTS

The positioning apparatus and method in accordance with the present invention provides consistent and reliable repeatability of testing equipment for obtaining RF measurements. The apparatus and method provides repeatable 3-dimensional placement of a wireless communication device against an artificial head or phantom device so that spacing from the artificial head and placement of the wireless communication device on the phantom device for all three axis of the 3-dimensional placement is controlled and maintained within reasonable constraints. The apparatus and method may also be customized to the shapes of various wireless communication devices. The apparatus and method further provides increased repeatability of articulated hand measurements and may be customized to ensure secure placement of a hand.

An aspect of the present invention is an apparatus for radio frequency testing of a wireless communication device including first and second portions. The apparatus comprises an artificial head and a spacer. The artificial head includes a mouth and an ear, and may further include a cheek, and the spacer is positioned adjacent to the artificial head. The spacer positions the first portion of the wireless communication device adjacent to the ear of the artificial head, directs the second portion of the wireless communication device toward the mouth of the artificial head, and positions the second portion of the wireless communication device a particular distance from the mouth of the artificial head.

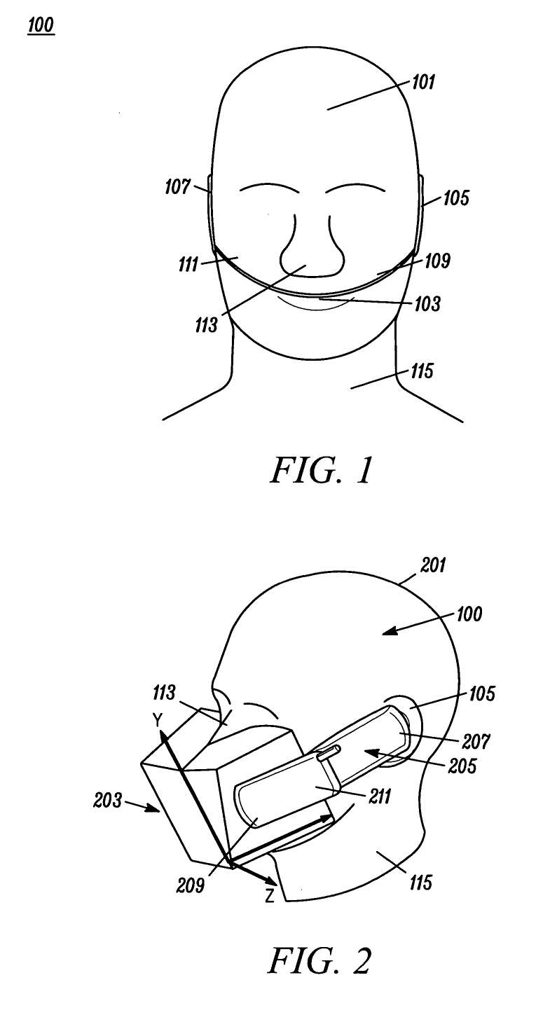

Referring to FIG. 1, there is shown an exemplary artificial head 100 or, more particularly, the front part of the head. In accordance with the present invention, the artificial head 100 includes a mouth 103 and at least one ear. For example, as shown in FIG. 1, the exemplary artificial head 100 of FIG. 1 includes a left ear 105 and a right ear 107. The artificial head 100 also includes a cheek located between each ear 105, 107 and the mouth 103. For the embodiment shown in FIG. 1, the exemplary artificial head 100 of FIG. 1 includes a left cheek 109 located between the left ear 105 and the mouth 103 and a right cheek 111 located between the right ear 107 and the mouth. The artificial head 100 may also include other notable components, such as a nose 113 and a head base 115.

Referring to FIG. 2, there is shown a frontal, side view of the artificial head 100, which partially shows the back part 201 of the head. In particular, FIG. 2 shows a spacer 203, in accordance with the present invention, and a wireless communication device 205 supported by the spacer adjacent to the head 100. The spacer 203 may be constructed, in whole or in part, of a low loss dielectric material, such as a material having a dielectric similar to air. Although a wireless communication device 205 is shown and described herein, it is to be understood that the present invention is applicable to any type of device that may benefit from radio frequency (“RF”) testing, such as a cellular telephone, a computer, a personal digital assistant, and the like. The wireless communication device 205 may be capable of communicating with one or more the wireless communication networks utilizing cellular-based communications such as analog communications (using AMPS), digital communications (using CDMA, TDMA, GSM, iDEN, GPRS, or EDGE), and next generation communications (using UMTS or WCDMA) and their variants; a peer-to-peer or ad hoc communications such as HomeRF, Bluetooth and IEEE 802.11 (a, b or g); and other forms of wireless communication.

The wireless communication device 205 may have a unitary housing, such as a “candy-bar” phone, or a multi-part housing, such as a “clam-shell” phone. For example, the wireless communication device 205 shown in FIG. 2 includes a first or upper portion 207 having an audio output component and a second or lower portion 209 having an audio input component. The audio output component of the first portion 207 may be located near the ear 105 of the artificial head 100, and the audio input component of the second portion 209 may be directed toward, or located near, the mouth 103 of the artificial head. Since the wireless communication device 205 shown in FIG. 1 has a multi-part housing, a joint or hinge 211 is located between the first and second portions 207, 209 of the device.

In accordance with desired standards, the spacer 203 positions the first portion 207 of the wireless communication device 205 adjacent to two points of the ear 105, 107 and one point of the cheek 109, 111. For example, these points are exemplified by a specification title “Test Plan for Mobile Station Over the Air Performance: Method of Measurement for Radiated RF Power and Receiver Performance”, Revision 2.1, by the CTIA Certification (April 2005). For the present invention, one embodiment of the spacer 203 may have a wedge-shaped structure that is molded or machined to fit the contours of the phantom or artificial head 100 on one side and sculpted to precisely position a device under test 205 on the other. The spacer 203 may be constructed of a material that maximizes durability and maintains acceptable RF qualities. An example of such material includes, but is not limited to, Expanded Poly-Styrene. The spacer 203 may be double-sided to allow support for phones on either side of the artificial head, or single-sided to cover only the left side or the right side of the artificial head at one time.

For embodiments that utilize the two-sided spacer, each embodiment may provide a precise and repeatable molded area to match up with the contours of the phantom or artificial head 100 and provides serviceability for RF testing on either side of the head 100 with a single placement.

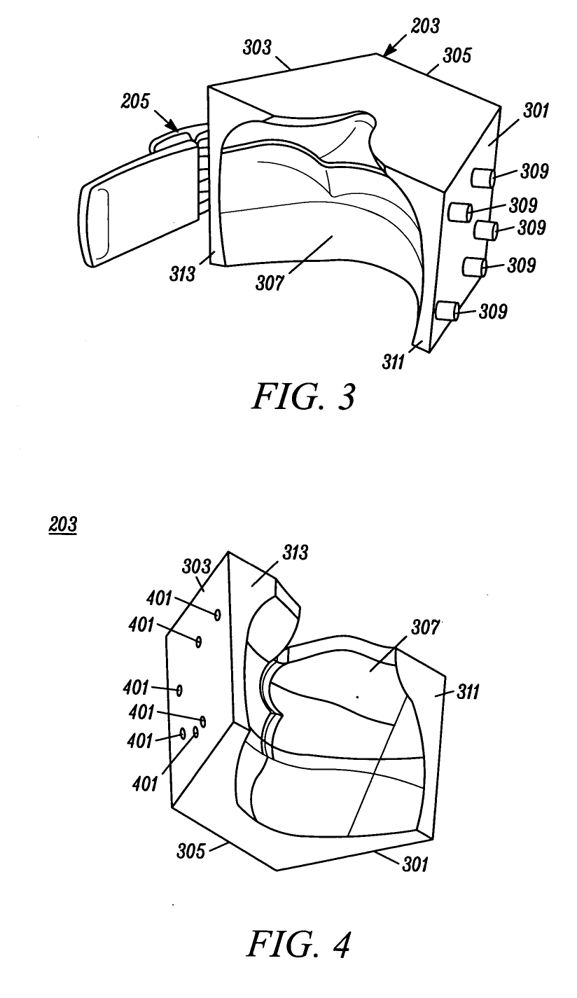

Referring to FIG. 3, there is shown a rear view of the spacer 203 and the wireless communication device 205. The spacer 203 includes at least one outer surface to support the wireless communication device 205, such as outer surfaces 301 and 303 for the particular embodiment shown. The spacer 203 may also include other outer surfaces, such as outer surface 305 for the particular embodiment shown. The spacer 203 also includes an inner surface 307 that may be positioned adjacent to the artificial head 100. For example, the inner surface 307 may fit uniquely to one position of the phantom or artificial head 100, such as the front part 101, thus forcing the spacer to mount at the same location on the head each time it is used. The inner surface 307 may be designed to, partially or completely, cover the mouth 103, cheek 109, 111 and/or nose 113 of the artificial head 100. The outer surface or surfaces 301, 303 of the spacer 203 may be adapted to fit different sizes and shapes of phones and different flip angles of clam shell phones by, for example, changing a descriptive computer file before molding or machining a new set of spacers.

The spacer 203 may also incorporate position nodes 309, 401 that are integral or adaptable to an outer surface 301, 303 of the spacer. The position nodes 309 guide the positioning of the device, and optionally other components such as an artificial hand described below, relative to the artificial head 100.

For one embodiment, as shown in FIG. 3, the positioning nodes 309 may protrude from an outer surface 301, 303 of the spacer 203 around the device 205 to provide repeatable placement of the device to the spacer and adjacent to the artificial head 100. For one example of this embodiment, the positioning nodes 309 may be molded into the structure of the spacer 203. For another example of this embodiment, the spacer 203 may be tapped so that hollow rods of a low loss dielectric material may be inserted into the side of the spacer to create the positioning nodes 309 at desired locations.

Referring to FIG. 4, there is shown another rear view of the spacer but, unlike FIG. 3, the wireless communication device 205 is not shown. The embodiment shown in FIG. 4 is similar to the one shown in FIG. 3, except that the positioning nodes 401 of this embodiment, which provide repeatable placement of the device to the spacer and adjacent to the artificial head 100, recess from an outer surface 301, 303 of the spacer 203. Thus, the positioning nodes 401 for this embodiment are recesses; not protrusions as described for the embodiment above. For one example of this embodiment, the positioning nodes 309 may be molded into the structure of the spacer 203 to provide a “groove” to support the device 205. For another example of this embodiment, the spacer 203 may be tapped so that hollow rods of a low loss dielectric material may be inserted into the positioning nodes 401 of the spacer to create support for the device 205 at desired locations.

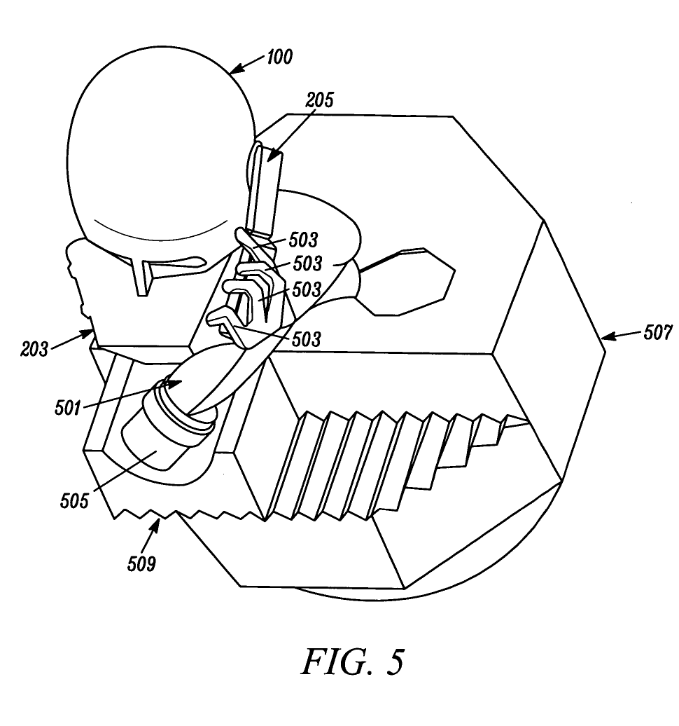

Referring to FIG. 5, there is shown the spacer, the wireless communication device and the artificial head along with a few addition components. In particular, an artificial hand 501, which may optionally include one or more fingers or digits 503, is positioned adjacent to the wireless communication device 205. The artificial hand 501 may be constructed, in whole or in part, of a low loss dielectric material, such as a material having a dielectric similar to air. The artificial hand may be added to the RF testing of the wireless communication device 205 in order to simulate the effects of a human hand, similar to the way that the artificial head 100 simulates the effects of a human head. A lower support 505 of the artificial hand may be supported by a hand base 509, and both the hand base 509 and the artificial head 100 may be supported by a pedestal 507.

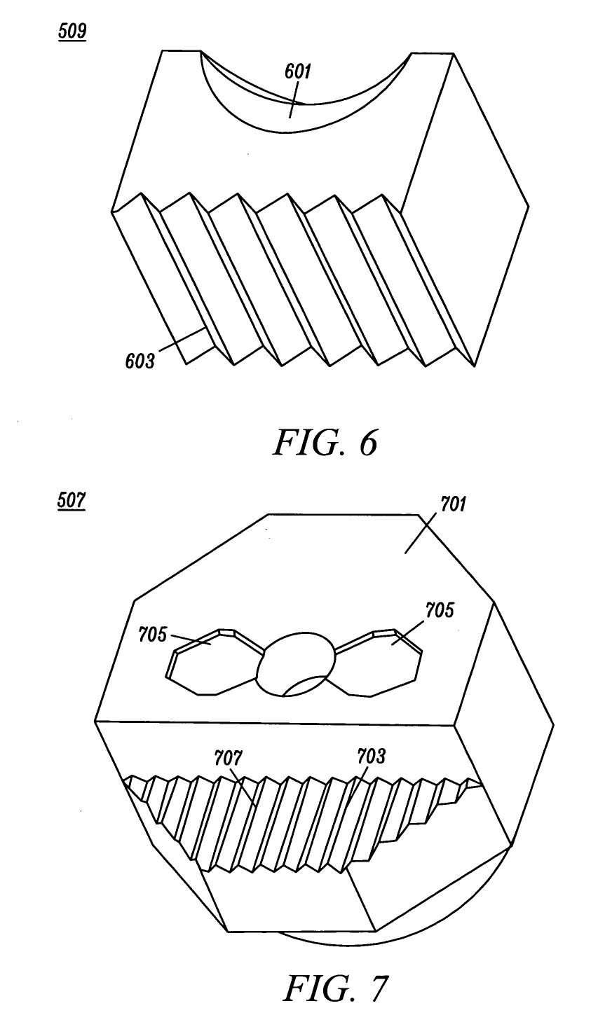

Referring to FIG. 6, there is shown the hand base without the other components of FIG. 5. The spacer 203 may also be configured to position, and possibly secure, a phantom or artificial hand 501 relative to the device 205 and adjacent to the artificial head 100. The hand based 509 includes one or more hand receiving surfaces 601 and a pedestal supported surface 603. For one embodiment, the hand receiving surface 601 may have an arcuate, concave shape to support the lower support 505 of the artificial hand 501 at various angles relative to the device 205 and the artificial head 100. For another embodiment, the pedestal supported surface 603 may have a contoured surface, such as the jagged surface shown in FIG. 6. This contoured surface of the pedestal supported surface 603, in conjunction with the pedestal 507, maximizes control of positioning the artificial hand 501.

Accurate placement of the positioning nodes (309, 401), particularly the positioning nodes located at upper positions, also provides a guide for placement of the fingers or digits 503 of the artificial hand 501, if utilized, minimizing measurement-to-measurement variability attributed to repeated hand placements. Placement nodes (309, 401), such as inserted placement nodes, may also be used to attach a molded or advanced hand design to the spacer 203, allowing the spacer, device 205, and hand 501 to be assembled on the phantom or artificial head 100 or, in the alternative, assembled together before placement on the artificial head.

Referring to FIG. 7, there is shown the pedestal 507 without the other components of FIG. 5. The pedestal 507 includes at least two levels, such as an upper level 701 and a lower level 703 as shown in FIG. 7. The upper level 701 may includes one or more head receiving areas 705 to support the head base 115 of the artificial head 100. If an upper level 701 includes multiple head receiving areas, then the artificial head 100 may be moved from area-to-area in order to provide varying positions for obtaining different measurements for testing. The lower level 703 may includes a base supporting surface 707 to support the hand base 509. The pedestal supported surface 603 of the hand base 509 may have a contoured surface that corresponds to the contour of the base supporting surface 707 to restrict lateral movement of the hand base along the base supporting surface. Also, the base supporting surface 707 of the pedestal 507 may have a greater length than the pedestal supported surface 603 of the hand base 509, so that the base supporting surface may receive the pedestal supported surface at a plurality of positions along the base supporting surface. Thus, as the artificial head 100 is moved from one head receiving area 705 to another, the artificial hand 501 and the hand base 509 may be repositioned to an appropriate position relative to the artificial head accordingly.

The spacer 203, and other components described herein, maximizes measurement-to-measurement repeatability of phantom or artificial head 100 and hand 501 testing by providing a uniform and repeatable spacing between the wireless communication device 205 and the artificial head, maximizing the repeatability of device placement relative to the head by providing placement guides to allow the device under test to be placed in the same position on the head time-after-time, and provides reference structures for placing the phantom or artificial hand onto the device and head in a repeatable fashion. In addition, the spacer 203, and other components described herein, minimize the measurement-to-measurement variability of phantom or artificial head and hand testing by introducing a spacer that provides a repeatable spacing between the device 205 and the head 100, and maximizing the repeatability of phone placement by providing placement guides or positioning nodes to allow the device under test to be placed in the same position relative to the head time-after-time. The pedestal 507 and the hand base 509 aid placement of the hand 501 relative to the device 205 and the head 100, and minimize variability involved with hand placement.

It is to be understood that the spacer 203, in accordance with the present invention, is not limited to the front part 101 of the artificial head. For example, a substantial portion of the spacer 203 may be positioned at the back part 201 of the artificial head 100, thus supporting the wireless communication device 205 from the back part, instead of the front part 101 of the head. Likewise, the spacer 203 may be positioned at an upper part and/or lower part of the artificial head 100.

While the preferred embodiments of the invention have been illustrated and described, it is to be understood that the invention is not so limited. For example, the composition of the materials used to produce the embodiments of the present invention should be rigid enough to support a wireless communication device and have properties that minimize any interference with radio frequency testing. Numerous modifications, changes, variations, substitutions and equivalents will occur to those skilled in the art without departing from the spirit and scope of the present invention as defined by the appended claims.

What is claimed is:

1. An apparatus for radio frequency testing of a wireless communication device including first and second portions, the apparatus comprising:
an artificial head including a mouth and an ear; and
a spacer positioned adjacent to the artificial head, the spacer being effective to position the first portion of the wireless communication device adjacent to the ear of the artificial head, direct the second portion of the wireless communication device toward the mouth of the artificial head, and position the second portion of the wireless communication device a particular distance from the mouth of the artificial head.

2. The apparatus according to claim 1, wherein:
the artificial head includes a cheek; and
the spacer positions the first portion of the wireless communication device adjacent to two points of the ear and one point of the cheek.

3. The apparatus according to claim 1, wherein the spacer covers at least a portion of the mouth of the artificial head.

4. The apparatus according to claim 1, wherein the spacer includes at least one surface having at least one protrusion to support the wireless communication device.

5. The apparatus according to claim 1, wherein the spacer includes at least one surface having at least one recess to support the wireless communication device.

6. The apparatus according to claim 5, wherein the spacer includes two surfaces configured to support the wireless communication device at two different sides of the artificial head.

7. The apparatus according to claim 1, wherein the spacer is positioned adjacent to a front part of the artificial head.

8. The apparatus according to claim 1, wherein the spacer is positioned adjacent to the mouth of the artificial head.

9. The apparatus according to claim 1, wherein the spacer is positioned adjacent to a back part of the artificial head.

10. The apparatus according to claim 1, wherein the first portion of the wireless communication device includes an audio output component and the second portion of the wireless communication devices includes an audio input component.

11. The apparatus according to claim 1, wherein the spacer includes a substantially rigid surface contoured to a particular surface of the artificial head.

12. The apparatus according to claim 1, wherein the spacer includes an adjustable surface that conforms to a surface of the artificial head.

13. The apparatus according to claim 1, wherein the wireless communication device includes a hinge located between the first and second portions of the wireless communication device.

14. The apparatus according to claim 1, wherein the first and second portions of the wireless communication device are generally at fixed positions relative to each other.

15. The apparatus according to claim 1, further comprising an artificial hand positioned adjacent to the wireless communication device.

16. The apparatus according to claim 15, further comprising:
a base being effective to support the artificial hand; and
a pedestal including first and second surface, the first surface being effective to support the base and the second surface being effective to support the artificial head.

17. The apparatus according to claim 16, wherein:
the base includes a first contoured surface; and
the first surface of the pedestal includes a second contoured surface being effective to receive the first contoured surface of the base at a plurality of positions along the second contoured surface.
